(19) United States
(12) Patent Application Publication
(10) Pub. No.: US 2011/0282861 A1
(43) Pub. Date: Nov. 17, 2011

(54) EXTRACTING HIGHER-ORDER KNOWLEDGE FROM STRUCTURED DATA

(75) Inventors: Thomas Frank Bergstraesser, Kirkland, WA (US); Vijay Mital, Kirkland, WA (US); Darryl Ellis Rubin, Duvall, WA (US)

(73) Assignee: Microsoft Corporation, Redmond, WA (US)

(21) Appl. No.: 12/777,564

(22) Filed: May 11, 2010

(51) Int. Cl. G06F 17/30

(52) U.S. Cl. 707/710; 707/792; 707/780; 707/E17.076; 707/E17.014; 707/E17.108

(57) ABSTRACT

Systems and methods are described for use in higher-order-knowledge-based searching of content available from a network of data-storage devices. In various embodiments, at least one computational expression representative of a relational framework for content is identified and provided to an information retrieval system for use in searching for content desired by a user. The relational framework for content may include rules, expressions, equations, and/or constraints, which bind, relate, or associate certain content with other content. A computational expression may be determined from processing structured data. The structured data may be identified during crawling of a network or may be expressly provided to an extractor. Use of a computational expression by an information retrieval system may more efficiently and accurately return desired content to a user than is possible with traditional information searching methods.

### BACKGROUND

Currently, the world-wide web provides a vast source of information stored as data at millions of computer-managed storage devices in communication over the Web. As used herein, “information” or “content” may refer to any type and form of informational material as well as processor-executable applications available in a network of computing devices, e.g., text, acoustic (e.g., songs), numerical (e.g., graphs, tables), video, audio-visual, historical, statistical, interactive web pages, scripts, etc. Today, a person may use a personal computer or a mobile communication device at almost any location in the world to easily access the vast source of information.

Although enormous amounts of information is readily available, it is often difficult for a person or “user” of the network to search for and retrieve particular content that may be desired by the user. For example, when current searching tools are employed, thousands or millions of “hits” may be returned to a user, for which the hits may be ranked by closeness to keywords entered by the user compared to words retained in an index identifying a web page and by current popularity, e.g., based on a number of links to a web page. A particular content desired by the person may not be popular, and its retrieval may require extensive searching and/or tedious review of hundreds of hits before the desired content may be identified and retrieved by the user. In many instances, a traditional search engine returns a plethora of hits which are irrelevant to the information desired by the user. Also, desired content may be related to other content in ways that are difficult to express as a traditional search query.

### SUMMARY

The present invention provides methods and systems for identifying higher-order knowledge that may characterize information that would be responsive to a user request for desired content. In various aspects, the higher-order knowledge is indicated by the presence of data structured according to certain structure types, e.g., lists, tables, sequences, spreadsheets, etc. A relational framework comprising any combination of constraints, rules, expressions, and conditions can govern the structuring of the data and be representative of the higher-order knowledge. The constraints, rules, expressions, and conditions can bind, relate, and/or associated certain data with other data. In various embodiments, the relational framework can be identified and represented by at least one computational expression which is executable by a computer. The computational expression may be provided to an information retrieval system, e.g., a system having a search engine adapted to use the computational expression in a search stack. The systems and methods described herein may be used, for example, to search for desired content accessible on the world-wide web by finding and retrieving content that has characteristics reflected in the higher-order knowledge captured by the computational expressions. Searching methods utilizing higher-order knowledge may provide more efficient searching of vast databases as compared to traditional searching methods, and more accurately identify content desired by a user.

In certain embodiments, a computational expression representative of a relational framework is determined by the information retrieval system, or an intermediary, from received data which is processed in an automated or semi-automated manner to identify the relational framework and convert it to one or more computational expressions. In some embodiments, a computational expression and/or a relational framework may be identified based on metadata associated with data received by the information retrieval system. In some cases, a relational framework may alternatively be identified based on pattern matching or other processing techniques. Any computational expression identified by the information retrieval system may be provided to a search stack for inclusion in a searching process. The search stack may locate, retrieve, and/or filter data in accordance with the computational expression. In this manner, search results reflective of higher-order knowledge may be returned to a user requesting desired content.

Described herein is a system for searching for and retrieving information on a plurality of data storage devices. The system comprises at least one input component configured to receive data from at least one networked data storage device, and at least one output component configured to transmit data to at least one information retrieval system. The system further includes at least one processor adapted to receive data structured according to at least one relational framework. In various embodiments, the relational framework represents at least one characteristic of a higher-order knowledge. The processor may further be adapted to process the received data to identify the at least one relational framework, and represent the relational framework as one or more computational expressions. In various embodiments, the computational expressions are executable by at least one computer processor. The processor which identifies the relational framework and represents it as one or more computational expressions may provide the computational expressions to in information retrieval system adapted to incorporate the computational expressions in a search stack, which locates and retrieves content desired by a user.

Useful methods may also be carried out in conjunction with the system as described above. In one embodiment, a method for use in searching for and retrieving information stored on a plurality of data storage devices comprises receiving, by at least one processor in communication with an information retrieval system, data structured according to at least one relational framework. The method may further include processing, by the at least one processor, the received data to identify the relational framework, and representing, by the at least one processor, the relational framework as one or more computational expressions, which are executable by at least one computer processor.

It will be appreciated that the invention may be embodied in a manufactured, non-transitory, computer storage medium as computer-executable instructions or code. In various embodiments, the instructions are read by a computer-processor-based system and adapt the system to execute the method steps as described above, or method steps of alternative embodiments of the invention as described below.

The foregoing is a non-limiting summary of the invention, which is defined by the attached claims

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high level block diagram illustrating a computing environment in which some embodiments of the invention may be practiced;

FIG. 2 is an architectural block diagram of an embodiment of a search stack adapted to execute computational expressions associated with higher-order knowledge of data relationships;

FIG. 3 depicts types of statements that may comprise the specification of a declarative model;

FIG. 4 is a diagram of an example of statements, such as those that may be specified for the declarative model of FIG. 3;

FIG. 5 is a flowchart of a process that may be performed during execution by a search stack, according to some embodiments;

FIG. 6 is an example of a user interface via which a user may enter a search query and view displayed information returned in response to the query;

FIG. 7A is a block diagram illustrating an embodiment of a system for identifying computational expressions representative of relational frameworks;

FIG. 7B depicts an embodiment of data relationships according to a high-order knowledge; and

FIGS. 8A-8B are flow diagrams depicting embodiments of methods for identifying computational expressions representative of relational frameworks for use in higher-order-knowledge-based searching.

### DETAILED DESCRIPTION

### Overview

The method and system embodiments described herein are directed to identifying from structured data higher-order knowledge, which may be used in a computer-processor-based information retrieval system. The higher-order knowledge may be formatted such that the information retrieval system can apply the knowledge to locate and retrieve content and/or data desired by a user of the system. Higher-order-knowledge-based searching may improve the efficiency and accuracy of identifying, by the information retrieval system, content and data desired by the user.

For purposes of understanding, several terms used throughout this disclosure are defined as follows. The term “higher-order knowledge” refers to the abstract reasoning which defines patterns, relationships, rules, etc. reflected in a grouping of data. The term “structured data” is used to refer to a block or group of data having a structure. The term “structure type” is used to refer to an identifiable type of structure such as a table, list, sequence, or spreadsheet of data. The term “relational framework” is used to refer to rules, expressions, bindings, calculations, etc. that relate certain data to other data in a structured data set. There may be any combination of rules, expressions, bindings, calculations, or other computational expressions that are characteristic of a higher-order knowledge and reflected in the structured data. The term “computational expressions” is used to refer to computer-executable expressions represented as computer code or in any other suitable machine language.

By way of introduction and for heuristic purposes, an example of higher-order-knowledge identification and searching based on higher-order knowledge is now described.

Conventional search engines are well adapted for crawling a network to identify terms or keywords identified in web pages, web sites, or any data store exposed to a search engine. These terms may be used to index the pages, sites, or data stores. The conventional search engines, however, are not adapted to extract higher-order knowledge of how content may be organized at these sources of information. For example, the data at a source of information may include data related to other data available from the source. If the higher-order knowledge inherent in ordering the data were known and could be applied by an information retrieval system, the information retrieval system could better locate information responding to a user request.

In some embodiments, an information retrieval system may process received data to identify a relational framework implicitly or explicitly contained in the data. This relational framework may be represented in a format that may be applied by the information retrieval system while generating information in response to a user request. In some embodiments the higher-order knowledge may be represented as an information model that may contain one or more computational expressions, representative of an equation, constraint or rule. Simple examples of data structure types with an organization that may reflect implicit higher-order knowledge are spreadsheets, lists, tables, or sequences. Additional examples of higher-order knowledge include graphs, charts, relational diagrams, etc. In various embodiments, an information retrieval system of the present invention is adapted to identify relational frameworks representative of higher-order knowledge in data exposed on a network to a search engine, and generate one or more computational expressions that capture the higher-order knowledge. The one or more computational expressions may be incorporated into a an existing model or may define a new model that is used by the information retrieval system. Though, it should be appreciated that the data processed to generate a model representative of higher-order knowledge may come from any suitable source and, in some embodiments, may be supplied specifically for generating a model to be used by an information retrieval system.

As one example of structured data having an implicit higher-order knowledge, consider a document storing a survey result or a statistical result provided by a government agency in which the five most cited factors (F₁, F₂, . . . F₅) influencing a home buyer's decision are listed in order of importance. These factors might be: F₁ neighborhood, F₂ price, F₃ size, F₄ distance from work, and F₅ age of building. The factors might be provided in an ordered list or table showing the factor and a number of times the factor was cited. The list or table of data reveals a relational framework representative of the higher-order knowledge. The information retrieval system described herein may identify the relational framework exhibited by the data, e.g., an ordered list of the five most important factors influencing a home purchase, and utilize this information, in the form of one or more computational expressions, in a search model executed by the information retrieval system. As an example of how the extracted higher-order knowledge, captured in the one or more computational expressions, may benefit an information retrieval system, the following simple scenario is considered.

A user of a computer-processor-based information retrieval system may enter the terms “house,” “realtor,” and “Eastowne” in a search query in an effort to find information about homes for sale in the vicinity of Eastowne. The terms of a search query can reflect a portion of the context of the search. Though, any information available to the information retrieval system may form the context, including prior searches conducted by the user, a user profile or other information about the user. In this example, the context could indicate that the user is looking for houses for sale in the village of Eastowne. The information retrieval system may incorporate in a search stack computational expressions which capture the higher-order knowledge that people looking to buy homes weigh five factors most in a particular order of importance. The information retrieval system may locate, retrieve, and provide search results to the user reflective of the higher-order knowledge and optionally any additional input provided by the user in response to prompts associated with the higher-order knowledge. In this manner, user-desired content may be more efficiently retrieved which is pertinent to the user's needs.

It will be appreciated that other types of structured data listed above may be identified and mined for relational frameworks representative of higher-order knowledge. Once a relational framework is identified, one or more computational expressions may be generated by the information retrieval system and/or by a user of the system which capture the higher-order knowledge. The computational expressions may then be incorporated in a search stack to more efficiently and accurately provide search results to a user of the system.

As another example, it is expected that structured data, e.g., data and/or content organized according to one or more relational frameworks, will become increasingly important to access and search by information retrieval systems. At present, data owners/publishers are beginning to expose really simple syndication (RSS) web feeds, web services and spreadsheet files to search engines. However, search engines are not presently configured to capture and index higher-order knowledge about relationships between data and/or content that the publishers/owners possess, or which may be added by aggregators or curators of the data.

As another example, by processing data representing an RSS feed representing data from a weather station, a relationship may be identified between a symbol “° C.,” a time and a value indicative of a temperature at a specific time. With a conventional search engine, specifying a query to return that information using conventional search queries would be difficult. The difficulty would be compounded if a user is searching for an average or maximum temperature over an interval. However, by capturing in a model the higher order knowledge reflected in the ordering of data in the RSS feed, the desired information can be generated automatically by applying that model.

Also, a large amount of the world's structured data already exists in the form of spreadsheets. Spreadsheets may be used to consolidate and correlate data from different sources, clean it up, and share the data. The information within the spreadsheets may include, implicitly and/or explicitly, higher-order knowledge about the data, e.g., knowledge in the form of computed columns and other calculational relationships. At present, there is no way for search engines to extract this higher-order knowledge from spreadsheets, or other types of structured data and/or content, and index the knowledge in a way that may affect search results. Furthermore, there is no way for data and content owners, publishers, aggregators or curators to add higher-order knowledge to their data beyond, e.g., means provided by spreadsheets. In particular, equations, constraints and rules that represent higher-order knowledge about the structured data is not presently exposed to search engines.

In various embodiments of the present invention, at least one computer processor is adapted to identify relational frameworks representative of higher-order knowledge of structured data. The identifying of relational frameworks may comprise identifying or generating at least one computational expression representative of a relational framework. The computational expression may be provided to an information retrieval system for use in searching, in a networked computing environment, for user-desired content.

### System Embodiments

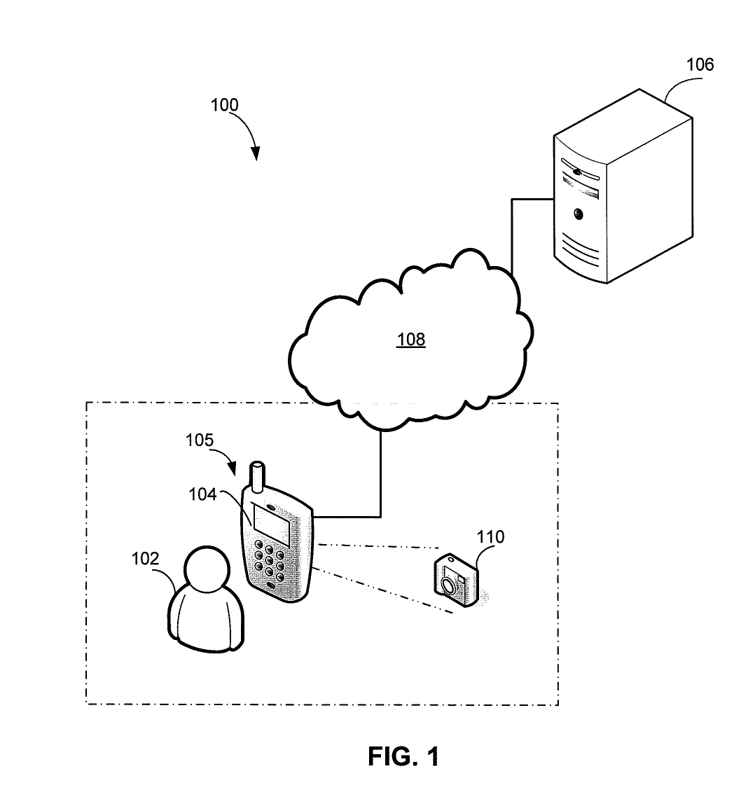

FIG. 1 is a high level diagram illustrating a computing environment 100 in which certain embodiments of the invention may be practiced. Computing environment 100 includes a user 102 interacting with a computing device 105. Computing device 105 may be any suitable computing device, such as a desktop computer, a laptop computer, a mobile phone, or a PDA. Computing device 105 may operate under any suitable computing architecture, and include any suitable operating system, such as variants of the WINDOWS® Operating System developed by MICROSOFT® Corporation.

Computing device 105 may have the capability to communicate over any suitable wired or wireless communications medium to a server 106. The communication between computing device 105 and server 106 may be over computer network(s) 108, which may be any suitable number or type of telecommunications networks, such as the Internet, a corporate intranet, or a cellular network. Server 106 may be implemented using any suitable computing architecture, and may be configured with any suitable operating system, such as variants of the WINDOWS® Operating System developed by MICROSOFT® Corporation. Moreover, while server 106 is illustrated in FIG. 1 as being a single computer, it may be any suitable number of computers configured to operate as a coherent system, e.g., a server farm, an intermediary processing device and a server, or an intermediary and a server farm. The intermediary processing device may be disposed in the system between the server and network, and may manage traffic to and from the server.

In the example of FIG. 1, the server 106, or an agent of the server or intermediary (neither shown), may operate as a search engine, allowing user 102 to retrieve information relevant to a search query. The user may specify the query explicitly, such as by inputting query terms into computing device 105 in any suitable way, such as via a keyboard, key pad, mouse, or voice input. Additionally and/or alternatively, the user may provide an implicit query. For example, computing device 105 may be equipped with (or connected via a wired or wireless connection to) a digital camera 110. An image, such as of an object, a scene, or a barcode scan, taken from digital camera 110 may serve as an implicit query.

Regardless of the type of input provided by user 102 that triggers generation of a query, computing device 105 may send the query to server 106 to obtain information relevant to the query. After retrieving data relevant to the search query, such as, for example, web pages, server 106 may apply one or more models to the data to generate information to be returned to user 102. In some embodiments, one or more models may be applied in conjunction with the search query to affect how the information retrieval system locates and retrieves the user-desired information. The information generated by server 106 may be sent over computer network(s) 108 and be displayed on display 104 of computing device 105. Display 104 may be any suitable display, including an LCD or CRT display, and may be either internal or external to computing device 105.

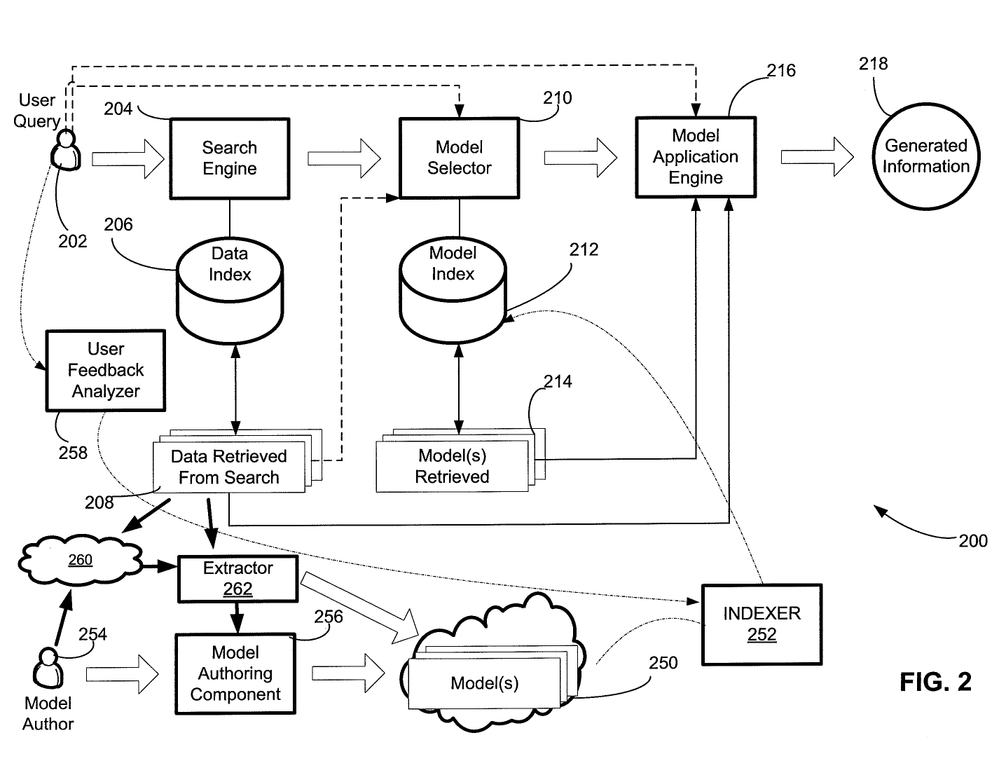

FIG. 2 is an architectural block diagram of a search stack 200 according to some embodiments, such as may be implemented by server 106 of FIG. 1. The components of search stack 200 may be implemented using any suitable configuration and number of computing devices, such as for purposes of load-balancing or redundancy. For example, the functionality described in connection with each component of the search stack may be performed by different physical computers or processor-based devices configured to act as a coherent system, and/or a single physical computer may perform the functionality ascribed to multiple components. In addition, in some embodiments, some of the functionality ascribed to a single component of the search stack may be distributed to multiple physical computers or processor-based devices, each of which may perform a different portion of a search computation in parallel.

Regardless of the specific configuration of search stack 200, a user query 202 may be provided as input to search stack 200 over a computer networking communications medium, e.g., input into a personal computer or PDA in communication with a network. The user query may be either implicit or explicit, as discussed in connection with FIG. 1. In the example of FIG. 2, user query 202 is provided to an input component in search stack 200, such as search engine 204, which may be any suitable search engine, such as the BING® search engine developed by Microsoft Corporation. Search engine 204 may be in communication with one or more storage media comprising a data index 206. Data index 206 may be stored on any suitable storage media, including internal or locally attached media, such as a hard disk, storage connected through a storage area network (SAN), or networked attached storage (NAS). Data index 206 may be in any suitable format, including one or more unstructured text files, or one or more relational databases.

Search engine 204 may consult data index 206 to retrieve data related to the user query 202. The retrieved data 208 may be a data portion of search results that are retrieved based on user query 202 and/or other factors relevant to the search, such as a user profile or user context. That is, data index 206 may comprise a mapping between one or more factors relevant to a search query (e.g., user query terms, user profile, user context) and data, such as web pages, that match and/or relate to that query. The mapping in data index 206 may be implemented using conventional techniques or in any other suitable way.

Regardless of the type of mapping performed using data index 206 to retrieve data relevant to the search, retrieved data 208 may comprise any suitable data retrieved by search engine 204 from a large body of data, such as, for example, web pages, medical records, lab test results, financial data, demographic data, video data (e.g., angiograms, ultrasounds), or image data (e.g., x-rays, EKGs, VQ scans, CT scans, or MRI scans). Retrieved data 208 may be identified and retrieved dynamically by search engine 204 or it may be cached as the result of a prior search performed by search engine 204 based on similar or identical query. Retrieved data 208 may be retrieved using conventional techniques or in any other suitable way.

The search stack 200 may also include a model selection component, such as model selector 210, which may select one or more appropriate model(s) 214 from a set of models stored on one or more computer readable media accessible to the model selector 210. The model selector 210 may then apply the selected model(s) 214 to the results (i.e., to retrieved data 208) of the search performed by search engine 204. In some embodiments, the selected model(s) 214 are applied to one or more steps of retrieved data responsive to the user query. Model selector 210 may be coupled to model index 212, which may be disposed with data index 206 or may be disposed as a separate index. Model index 212 may be implemented on any suitable storage media, including those described in connection with data index 206, and may be in any suitable format, including those described in connection with data index 206. The model index 212 may comprise a mapping between one or more factors relevant to the user's search (e.g., terms in user query 202, user profile, user context, and/or the retrieved data 208 retrieved by the search engine 204) and appropriate model(s) 214 that may be applied to obtain the retrieved data 208.

Selected models 214 may be selected from a larger pool of models 250 stored on computer-readable media associated with server 106 (FIG. 1). In some embodiments, pool of models 250 is supplied by an entity operating the search system. Though, in certain embodiments, all or a portion of the models in pool of models 250, from which models 214 are selected, are provided by parties other than the entity operating the search system. In some embodiments, models in the pool of models 250 are supplied by a user inputting user query 202. In such a scenario, a portion of pool of models 250 accessed by model selector 210 may include computer storage media segregated to store data personal to individual users, such as storing data for each user submitting user query 202. In certain embodiments, a community of users may have access to the search system, and pool of models 250 includes models submitted by users other than the user who submitted user query 202. In additional embodiments, some or all of the models in pool of models 250 from which models 214 were selected are provided by other third parties, for example, model author 254. Such third parties may include businesses or organizations that have a specialized desire or ability to specify the nature of information to be generated in response to a search query. For example, a model that computes commuting distance from a house for sale may be provided by a real estate agent. A model that computes comparative lab results may be provided by a medical association. Accordingly, it should be appreciated that any number or type of models may be incorporated in pool of models 250.

The models authored by third parties may be provided to the search stack for use in processing search queries. To author a model, a third party may use an authoring component, such as authoring component 256. Authoring component 256 may include an authoring tool that allows model author 254 to use a user interface that is part of the tool to specify information to be included in the model.

The authoring tool may be implemented and made available for use by users or other third parties in any suitable way. For example, it may be an executable program available for download and installation on a computing device operated by model author 254, or it may be an application that is executed on a server (which may or may not be part of the search stack) and is displayed to model author 254 in a web browser. The authoring tool may also be made available to any user 202 submitting a search query, e.g., made available as part of the search stack. As such, a user 202 may adapt an existing model, or a model generated by the information retrieval system or agent of the information retrieval system, for a particular search.

The user interface of authoring component 256 and the underlying specification of a model may be designed in such a way that a user who is not familiar with computer programming may author readily a model. For example, the user interface may receive user input defining a specification for the model. The user input may be in the form of declarative statements, such as expressions including constraints, equations, calculations, rules, and/or inequalities. Based on interactions of model author 254 with the user interface, the authoring tool may generate a model in a particular format, such as any suitable file format (e.g., text file, binary file, web page, XML, etc.). In one embodiment, declarative statements entered by the user to comprise a specification for the model are stored in a text file format, such as XML.

In certain embodiments, a model or at least a portion of a model is generated by the information retrieval system or an agent of the information retrieval system. An agent of the information retrieval system may include any computer-processor-based device in communication with the information retrieval system, e.g., a server, a computer, an intermediary device disposed in the network between the server 106 and the network 108. A model or a portion of a model may be generated by processing data to identify relational frameworks representative of higher-order knowledge.

The information retrieval system, or an agent of the information retrieval system, may include extractor 262. Extractor 262 may be a component of the information retrieval system, e.g., an application running on a server, or may be a separate element. The extractor 262 may be an application in operation on a processor in communication with the information retrieval system and/or in communication with the search stack 200. In some embodiments, the extractor 262 is in communication with the search engine 204, and may be adapted to receive as input at least some retrieved data 208. Though, data operated on by extractor 262 may be obtained from any suitable source, including from a “crawler” as is known in the art for discovering content on a network.

In certain embodiments, extractor 262 processes received data to identify whether the received data contains structured data of a certain structure type, e.g., a list, a sequence, a record, an array, a table, a spreadsheet, etc. The extractor 262 may identify a structured data type. Identification of a structured type may occur by pattern matching, or may occur by a structure type identifier included in the structured data. In some implementations, the extractor processes each retrieved data 208 to determine whether the structure reveals at least one relational framework. In some embodiments, the search engine 204 determines whether retrieved data 208 contains structured data of a certain structure type, and the search engine provides only such structured data 260 to the extractor 262. Though, data input to extractor 262 may come from any suitable source. For example, in yet additional embodiments, a model author 254 provides structured data 260 to the extractor 262.

In various embodiments, the extractor 262 processes structured data 260 to identify the at least one relational framework. Based on the relational framework, the extractor 262 may determine at least one rule, expression, equation, or constraint which binds or relates certain data of a structured data set to other data of the structured data set. As an example, the extractor 262 may determine that a first type of data is related to a second type of data based on data in two columns of a spreadsheet or table. For example, the data may be related by a mathematical equation. As another example, the extractor 262 can determine that certain types of events have a frequency of occurrence based on data in a list weighted according to ratios determined by number of votes, or number of times selected.

In certain implementations, the extractor 262 scans a spreadsheet received as structured data 260. The extractor 262 may scan the spreadsheet to extract explicit and/or implicit data structures manifest in the spreadsheet. For example, the extractor 262 may identify repeating rows, hierarchies, or explicitly marked table with column headings. The extractor 262 may, in some embodiments, identify bindings to external data sources such as external databases or analytical cubes. The extractor 262 may scan the spreadsheet to extract calculations and/or functions referred to in the spreadsheet. In certain embodiments, the extractor 262 scans the spreadsheet to extract metadata added to the spreadsheet, the metadata representative of information that may be part of or facilitate recognition of the relational framework.

In some embodiments, the extractor 262 determines a rule, expression, equation, or constraint binding or relating data by processing the structured data 260 and computationally finding the rule, expression, equation, or constraint which implicitly binds or relates the data. As simple examples, the extractor 262 may divide a first column of numbers in a spreadsheet by a second column in a spreadsheet to find a common multiplier or common additive factor. The relational frameworks for the data can then be identified as: second column is equal to first column times a multiplier, or second column is equal to first column plus an additive factor. This relational framework may be converted to one or more computational expressions, which are executable by a processor, and recorded as a model such that it may be applied in other scenarios in which data of the types in the first column or the second column are to be processed as part of responding to a user's request for information.

In some implementations, the extractor 262 determines a rule, expression, equation, or constraint binding or relating data by processing the structured data 260 and extracting the rule, expression, equation, or constraint which is explicitly included with the data. Other information may be used to identify the types of data to which such a relationship applies. As an example, structured data can include, in a header, as metadata, or according to a schema, an explicit identification of the types of data within the structured data. Though, the types of data that are related may be determined in any suitable way, including based on user input.

In yet additional embodiments, the extractor 262 determines a rule, expression, equation, or constraint binding or relating data in conjunction with input received from a model author 254. For example, the extractor 262 may determine that one or more portions of data in a received structure data 208 appear to be related by a rule, expression, equation, or constraint, but that the extractor is unable to determine an accurate relationship. This could occur, for example, when the extractor 262 processes data which when plotted is indicative of a trend. The extractor 262 may attempt to fit the data with a linear relationship, whereas the data is best fit with a higher order polynomial, exponential, or trigonometric function. In cases where the extractor 262 determines that a relational framework appears to be present but cannot accurately establish a rule, expression, equation, or constraint for the data, the extractor 262 may provide the data to a model author 254, or to user 202, so that the model author or user may assist in identifying the relational framework for the structured data. In cases where the extractor 262 determines that there are plural rules, expressions; equations, and/or constraints for structured data, the extractor 262 may provide the data and the candidate rules, expressions, equations, and/or constraints to a model author 254, or to user 202, so that the model author or user may disambiguate the rules, expressions, equations, and/or constraints to best identifying the relational framework for the structured data. Further, extractor 262 may automatically identify a relationship between types of data, but may require user input to determine the types of data joined by the relationship.

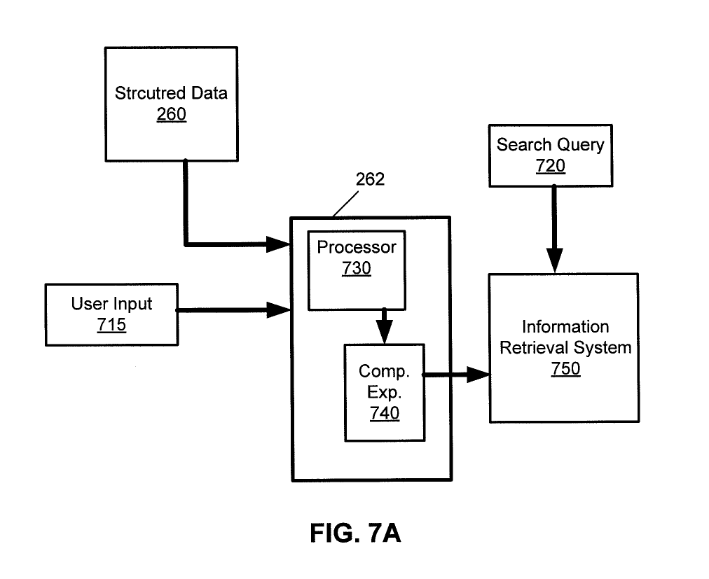

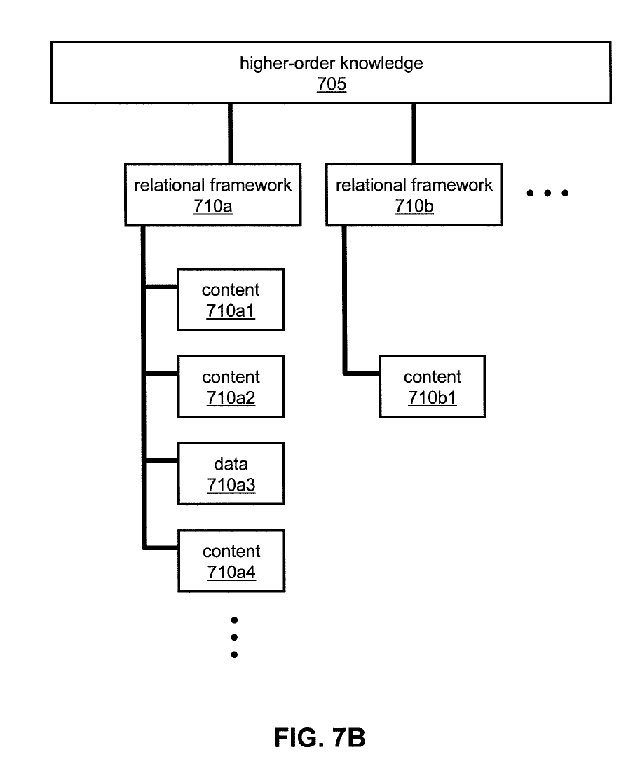

FIG. 7A depicts an embodiment of an extractor 262 which is in communication with an information retrieval system 750. In various embodiments, the extractor comprises at least one processor 730, at least one input to receive structured data 260, and at least one output to provide data, e.g., computational expressions 740, to the information retrieval system 750. The information retrieval system may receive a search query 720 and computational expressions 740, and affect a search on a search stack 200 responsive to the search query.

In various embodiments, at least one processor 730 of the extractor 262 is adapted to generate one or more computational expressions 740 that are representative of the rules, expressions, equations, and/or constraints for structured data 208 processed by the extractor. Each structured data processed may yield rules, expressions, equations, and/or constraints, which in turn yields a different set of computational expressions 740. In various embodiments, the computational expressions are provided to the information retrieval system 750 as indicated in FIG. 7A, and are executable by the information retrieval system. The computational expressions 740 may comprise any combination of mathematical expressions, Boolean expressions, conditional expressions, declarative expressions, constraints, rules, inequalities, etc., which are coded into any syntax or format recognizable for execution by the information retrieval system 750.

In some embodiments, computational expressions 740 provided to the information retrieval system 750 are incorporated as models 250 (FIG. 2) in the search stack 200. For example, a particular structured data 260 can be processed by the extractor 262 to yield at least one computational expression 740, which defines one model 250, indexed and stored in model index 212. In some implementations, several computational expressions 740 are incorporated into one model. The several computational expressions may be determined from one particular structured data 208 or from plural sets of structured data. Any model which is indexed by the information retrieval system 750 may be available for subsequent search processes.

In some implementations, the extractor 262 may provide indexing information along with the computational expressions to the information retrieval system 750. The indexing information can be used by the information retrieval system 750 to index the computational expressions 740 for storage and subsequent access by the information retrieval system 750. In some cases, the indexing information may be used to build an index so that a model, such as may be defined by the computational expressions 740, may be located in response to a user search query. In this way, a model may be identified and applied in response to a user's request for information such that the higher-order knowledge captured in the computational expressions may be used to generate information in response to the user's request. Because the information retrieval is guided by the higher-order knowledge, it is likely to be relevant to the user's request.

For heuristic purposes, FIG. 7B depicts one embodiment of the hierarchical relationship between structured data and higher-order knowledge. Returning to the example of residential real estate purchase set forth above, content 710b1 may be a government web page listing the five most frequently cited factors influencing purchases for home buyers. Extractor 262 may process the content 710b1 and identify five groupings of data present on the web page according to a relational framework 710b of a ranked list. The relational framework 710b revealed by such ranked list may be representative of a higher-order knowledge 705, e.g., home buyers weigh location, price, size, distance to work, and age of building most heavily when buying a home. Computational expressions that could be generated by an extractor to capture a portion of this higher-order knowledge may be expressions that can be applied in a context in which a user is seeking information on homes to purchase, such as: provide information relating to average home price in neighborhood, or rank search results first by location and then by price and size. Such computational expressions may be incorporated into a model 250, so that the model captures the higher-order knowledge.

Although only one content 710b1 is shown in FIG. 7B from which a relational framework may be identified, in some embodiments plural sets of data 710a1-710a4, e.g., multiple web pages, may be processed by extractor 262 to identify a relational framework 710a. For example and returning to the home purchase, plural web pages showing recent sale prices in a neighborhood may be processed to identify a “local price trend” relational framework.

Returning now to FIG. 2, in some embodiments in which authoring component 256 is executing as part of search stack 200 (such as if it is executing on a computing device operated by model author 254), model author 254 provides the model created using authoring component 256, or an existing or extractor-created model modified using authoring component 256, to the information retrieval system. In some embodiments, the extractor 262 provides computational expressions which are provided directly as a model. The information retrieval system may then store the provided model into pool of models 250. If the model provided by model author 254 or extractor 262 is not in a suitable format, authoring component 256 may first convert the provided model into the appropriate format, either automatically or based in part on information supplied by model author 254.

In some embodiments, to facilitate easy addition of models to pool of models 250, the search system illustrated in FIG. 2 includes an indexer 252. Indexer 252 may update model index 212 based on models contained within pool of models 250, including models provided by third parties, models generated by the information retrievel system, models generated by an agent of the information retrieval system, or models generated by the extractor 262. In some embodiments, each of the models in pool of models 250 contains meta tags identifying context in which the model may be applied. Indexer 252 may use this information similar to meta tags attached to web pages to construct model index 212. In this regard, indexer 252 may be implemented using technology known in the art for implementing a web crawler to build a page index. To support such an implementation, each of the models in pool of models 250 may be formatted as a web page. However, it should be recognized that any suitable technique may be used for constructing model index 212, including machine learning techniques or explicit human input.

To generate information in response to a user request, model selector 210 may be implemented using technology known in the art for implementing a search engine based upon an index. However, rather than identifying which pages to return to a user based on a data index, model selector 210 may employ model index 212 to identify models used in generating information to provide to a user and/or to incorporate in the search stack in response to a user query. Model selector 210 may identify models based on a match between factors relevant to the search and terms in the model index. Though, inexact matching techniques may alternatively or additionally be used. In some embodiments, the declarative models are themselves stored in model index 212, while in other embodiments, the models themselves are stored separately from model index 212, but in such a way that they may be appropriately identified in model index 212.

Search stack 200 may also include a model application engine 216, which may apply the selected model(s) 214 to the data 208 retrieved by search engine 204. In the application of a model, retrieved data 208 may serve as a parameter over which the selected model(s) is applied by model application engine 216. Additional parameters, such as portions of user query 202, may also be provided as input to the selected model(s) during model application. Though, it should be appreciated that any data available within the search environment illustrated in FIG. 2 may be identified in a model or used by model application engine 216 when the model is applied.

As a result of the application of the model to the search results performed by model application engine 216, information 218 may be generated. Generated information 218 may be returned to the user by an output component (not shown) of search stack 200. Though, the generated information may be used in any suitable way, including as a query for further searching by search engine 204. Generated information 218 may include the results of model application performed by model application engine 216, may include data 208 retrieved by the search engine 204, or any suitable combination thereof. For example, based on the application of a model performed by the model application engine 216, the ordering of the presentation to a user of data 208 may change, the content presented as part of retrieved data 208 may be modified so that it includes additional or alternative content that is the result of a computation performed by model application engine 216, or any suitable combination of the two. Thus, when selected model(s) 214 are applied to raw data, such as data 208 retrieved by a search engine, the generated information 218 may be at a higher level of abstraction and therefore be more useful to a user than the raw data itself.

After having received generated information 218 in response to the search query, a user 202 may provide feedback to search stack 200 related to the usefulness of a model that was applied as part of the production of generated information 218. Accordingly, search stack 200 may also include user feedback analyzer 258, which may receive such user feedback and analyze or process the user feedback. The result of the analysis performed by feedback analyzer 258 may be used to update model index 212, for example, to favor or disfavor a model associated with particular search terms based on the analysis of user feedback. Thus, updates to model index 212 based on user feedback may influence which model(s) is(are) selected by model selector 210 and applied to generate information returned in response to a search query. Model index 212 may be updated in any suitable way based on the analysis performed by feedback analyzer 258. As an example, feedback analyzer 258 may update model index 212 directly, or it may convey the appropriate information to indexer 252, which may itself update model index 212 on behalf of feedback analyzer 258.

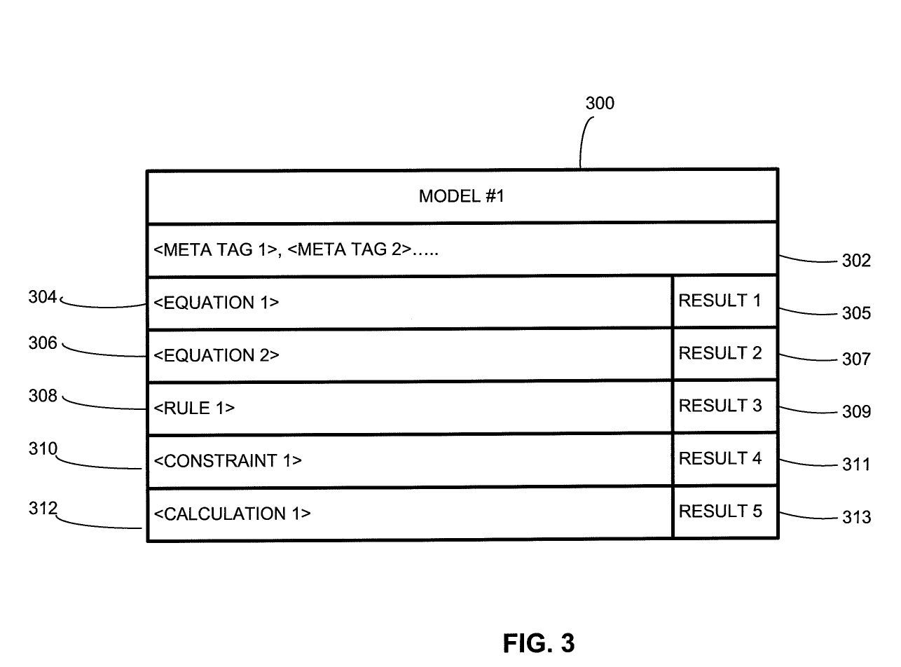

FIG. 3 is a sketch of a data structure of a declarative model 300, such as one of model(s) 214 selected by model selector 210 of FIG. 2. Model 300 may be stored in any suitable way. In some embodiments, a model is stored in a file, and is treated as a web page would be treated. Accordingly, in such embodiments, like other web pages, model 300 may include meta tags 302 to aid in indexing the model, such as in model index 212.

Model 300 may comprise one or more elements, which in the embodiment illustrated are statements in a declarative language. In some embodiments, the declarative language is at a level that a human being who is not a computer programmer may understand and author. For example, it may contain statements of equations and the form of a result based on evaluation of the equation, such as equation 304 and result 305, and equation 306 and result 307. In some embodiments, the language of a model is provided by the extractor 262. Language provided by the extractor 262 may be declarative, or may be a common computer language or script, e.g., C, C++, Java, or may be in machine language. An equation may encompass a symbolic or mathematical computation. An equation may be executed for a set of input data, or may be executed as part of the searching process.

Model 300 may also comprise statement(s) of one or more rules, such as rule 308 and the form of a result based on evaluation of the equation, such as rule result 309. The application of some types of rules may trigger a search to be performed, narrow a search to restrict retrieved data, or expand a search to collect new information. According to some embodiments, when a model such as model 300 containing a rule, such as rule 308, is applied, such as by model application engine 216, the evaluation of the rule performed as part of the application of the model generates a search query and triggers a search to be performed by the data search engine, such as search engine 204. Thus, in such embodiments, an Internet search may be triggered based on a search query generated by the application of a model to the search data. Although, a rule may specify any suitable result. For example, a rule may be a conditional statement and a result that applies, depending on whether the condition evaluated dynamically is true or false. Accordingly, the result portion of a rule may specify actions to be conditionally performed or information to be returned or any other type of information.

Model 300 may also comprise statement(s) of one or more constraints, such as constraint 310 and result 311. A constraint may define a restriction that is applied to one or more values produced on application of the model. An example of a constraint may be an inequality statement such as an indication that the result of applying a model to data 208 retrieved from a search be greater than a defined value.

Model 300 may also include statements of one or more calculations to be performed over input data, such as calculation 312. Each calculation may also have an associated result, such as result 313. In this example, the result may be labeled according to the specified calculation 312 such that it may be referenced in other statements within model 300 or otherwise specifying how the result of the computation may be further applied in generating information to a user. Calculation 312 may be an expression representing a numerical calculation with a numerical value as a result, or any other suitable type of calculation, such as symbolic calculations or string calculations. In applying model 300 to data 208 retrieved by a search engine, model application engine 216 may perform any calculations over data 208 that are specified in the model specification, including attempting to solve equations, inequalities and constraints over the data 208. In some embodiments, the statements representing equations, rules, constraints or calculations within a model may be interrelated, such that information generated as a result of one statement may be referenced in another statement within model 300. In such a scenario, applying model 300 may entail determining an order in which the statements are evaluated such that all statements may be consistently applied. In some embodiments, applying a model may entail multiple iterations during which only those statements for which values of all parameters in the statement are available are applied. As application of some statements generates values used to apply other statements, those other statements may be evaluated in successive iterations. If application of a statement in an iteration changes the value of a parameter used in applying another statement, the other statement will again be applied based on the changed values of the parameters on which it relies. Application of the statements in a model may continue iteratively in this fashion until a consistent result of applying all statements in the model occurs from one iteration to the next, achieving a stable and consistent result. Though, it should be recognized that any suitable technique may be used to apply a model 300.

In some embodiments, a model 300 may affect a searching process. For example, in response to a search query entered by user 202, the information retrieval system may select and incorporate a model into the search stack 200 in the process of locating and retrieving information. A selected model may narrow or expand a search. Returning to the example of a user 202 entering search terms pertinent to a residential real estate purchase, a “real estate home purchase” model may be selected by the information retrieval system, which may trigger several searching routines directed to locating and retrieving information about location, price, size, distance from work, and/or age of candidate dwellings.

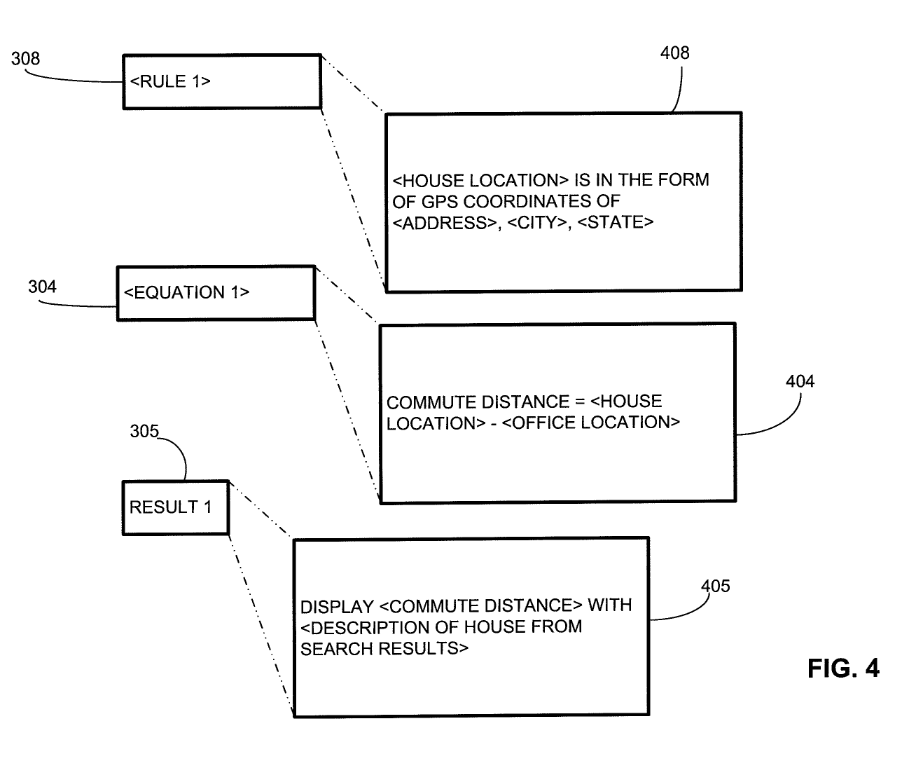

FIG. 4 provides an example of statements such as those that may be specified or extracted and generated by extractor 262 for model 300. In the example of FIG. 4, the model may be selected and applied when a user is performing a house search, and may in this example, relate houses for sale to the user's commute. Application of the model in the example of FIG. 4 may generate information on the commuting distance and/or time between each house for sale and the user's office location. Thus, rule statement 408 is an example of rule 308 from FIG. 3 that specifies the form of a house location to be used as part of the model computations. In this example, rule statement 408 specifies that a parameter, identified as a house location, be in the form of global positioning system (GPS) coordinates of the address, city and state of the house for sale. These parameters can, when the model is applied, be given values by model application engine 216 based on retrieved data 208. In this example, rule 308 may evaluate to true when a web page, or other item of retrieved data, contains information that is recognized as a house location by application of rule 308. Accordingly, rule 308 may be used to identify items of data for which other statements within the model are applied.

Equation statement 404 is an example of equation 304 of FIG. 3 that provides a computation to be performed to arrive at the commute distance, based on the location of the house for sale as specified in rule statement 408 and a value that may be available to model application engine 216, which in this example is indicated as the office location. In this example, the office location is an input parameter to the model that may have been provided, for example, as part of the user query, as part of the user's profile or user context. The house location, however, is based on the application of rule statement 408, received from another input to the model, such as data 208 that are returned as the result of the search engine.

Result statement 405 is an example of result 305 of FIG. 3 that specifies how to display the result of the computation performed for equation statement 404. Thus, result statement 405, in this example, specifies that the commute distance to each house for sale from the search results be displayed alongside the description of the house, which is a parameter for which a value may be established based on retrieved data 208.

The example of FIG. 4 illustrates some of the statements that may be present in a model to display results to a user query. In this example, the results relate to houses for sale. Accordingly, the model depicted in FIG. 4 may be selected by model selector 210 (FIG. 2) in response to a user query 202 requesting information on houses for sale. The model may be applied by model application engine 216 to every item of data in retrieved data 208. Though, not every retrieved item of data may comply with rule 308 or other conditions established by statements within the model. Accordingly, not every item of retrieved data 208 may be included in generated information 218. Though, FIG. 4 illustrates that other information, not expressly included within retrieved data 208, may be included in generated information 218. In the simple example of FIG. 4, a value of a parameter called “commute distance” is computed by model application engine 216 upon application of the selected model as depicted in FIG. 4.

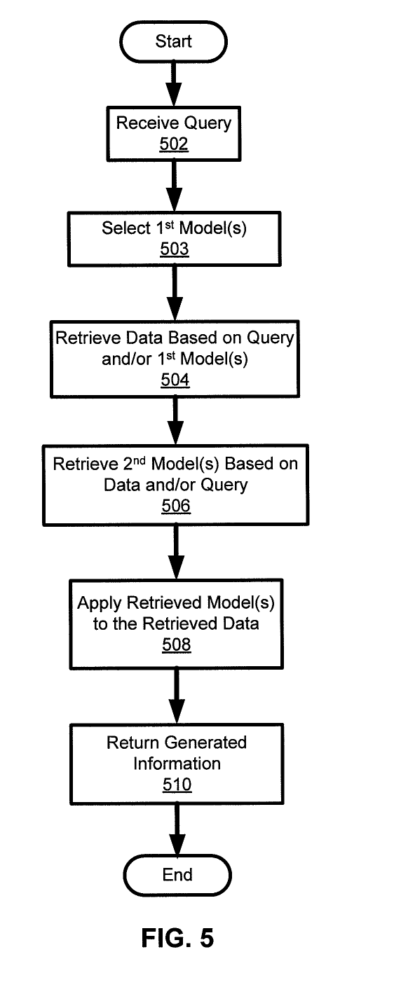

FIG. 5 is a flowchart of a process that may be performed during execution by a search stack, such as search stack 200 of FIG. 2, according to some embodiments. The process may start when a computing device, such as computing device 105 of FIG. 1, sends a search query on behalf of a user 202 to a search engine, such as search engine 204 of FIG. 2. Though, it is not a requirement that the search process be triggered by express user input or express user input in textual form. Non-textual inputs or implied user inputs may be regarded as a query triggering execution of the process of FIG. 5.

In step 502, the search stack may receive the user's query. As discussed above, a user's query may be either implicit or explicit. For example, in some embodiments, a search stack may generate a search query on behalf of the user. The search stack, for example, may generate a search query based on context information associated with the user. This may be performed for example, by search engine 204 of FIG. 2.

Regardless of how the query is generated, in step 503, a first model or set of models may be selected by the information retrieval system for incorporation into the search stack 200. The first model(s) may narrow or expand the searching process. The first model(s) may be authored or generated by extractor 262 or obtained in any other suitable ways. The implementation of first model(s) may or may not be used in a searching process.

In step 504, the search engine may then locate and retrieve data from a network having at least one data-storage device. The retrieved data may be selected based on matching terms of the search query, or based on executing the first model(s) in the search stack, or a combination of matching and executing. The data returned may be based on a match (whether explicit or implicit) between the query (and/or other factors, such as user context and a user profile) and terms in an index accessible to the search engine, such as data index 206 of FIG. 2.

The process then flows to step 506, in which the search stack may retrieve one or more second models appropriate to the user's search. In the exemplary implementation of FIG. 2, appropriate second model(s) may be selected by the model selector 210 in connection with an index (e.g., model index 212) relating a user's query and/or data returned by the search engine to one or more appropriate model(s). The second model(s) may be authored, generated by extractor 262, or may comprise a combination of authored and extractor-generated models.

At step 508, the search stack may then apply the retrieved second model(s) to the retrieved data 208. In the exemplary implementation of FIG. 2, this step may be performed by model application engine 216. In addition to the retrieved data itself, other factors relating to the search such as the user query (or one or more portions thereof) may also serve as input to one or more computations performed as a result of applying the second model(s) on the retrieved data. Processing at step 508 may entail multiple iterations. In some embodiments, a second model is applied to each item of data, such as a web page included in retrieved data 208. Accordingly, processing at step 508 may be iterative in the sense that it is repeated for each item contained within retrieved data 208. Alternatively or additionally, processing at step 508 may be iterative in that application of a second model, whether applied to an individual item of data or a collection of items of data, may entail iteratively applying statements in the second model until a stable and consistent result is achieved. Processing at step 508 may alternatively or additionally be iterative in the sense that multiple second model(s) may be selected by model selector 210 such that information in compliance with each of the selected second model(s) may be generated by processing at step 508.

Turning to step 510, the search stack may then output results generated as a result of the application of the second selected model(s) to the retrieved data. In this example the output may entail returning information to a user computer which may then render the information on a display for a user. In some embodiments, the generated information includes some combination of the result of applying the second model(s) on the data returned from the search engine and the data itself. For example, the generated information may filter or reorder the search data based on the application of the second model(s), or may provide additional information or information in a different format than the data returned by the search results. In some embodiments, the reordering of the search data may incorporate a time element. For example, a second model may identify a time order of a set of multiple events. Application of such a model may then entail identifying search data related to those events, and generating the information returned to the user in an order in accordance to the time order of the model. Though, it should be recognized that the nature of the information generated may be in any suitable form that may be specified as a result of application of a second model, which may contain a combination of elements, such as calculations, equations, constraints and/or rules.

After the data is returned to the user (via the user's computing device), the process of FIG. 5 may terminate.

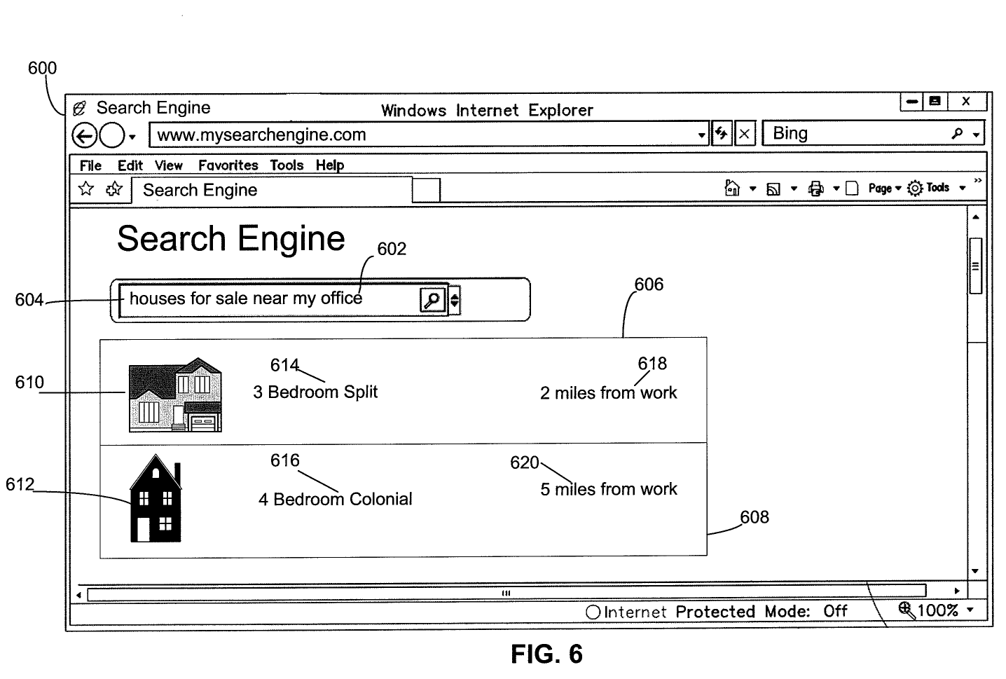

FIG. 6 is an example of a user interface by which a user may access and execute a search in an information retrieval system. In this example, a user may enter a search query and view information returned in response to the query. FIG. 6 illustrates that the interface is displayed by a web browser 600, although any suitable application to generate a user interface may be used. The web browser 600 may be any suitable web browser, illustrated in this example as being INTERNET EXPLORER® developed by Microsoft Corporation, and may execute on a computing device operated by the user (such as computing device 105 of FIG. 1). In the example of FIG. 6, the web browser has loaded a web page returned by an information retrieval system such as that illustrated in FIG. 2.

In the illustrated embodiment of FIG. 6, the user has entered a text query 604, “houses for sale near my office,” in a query input field 602 in the user interface, and sent that query via web browser 600 to a search engine that is part of a search stack according to some embodiments. In response, the search stack returned generated information to the user via the web browser, illustrated in FIG. 6 as returned information elements 606 and 608, which are displayed in the web browser.

After receiving the user's query, the search engine may retrieve a set of data (e.g., web pages) including results of houses for sale near the user's office. The set of data returned from the search engine may be based on matches between the query terms and terms in an index relating to the web pages, as discussed above. Though, as illustrated, other sources of data may be used in evaluating the search query. In this example, the search query includes the phrase “my office.” That phrase may be associated with information in a user profile accessible to the search and retrieval system processing the query. Accordingly, on execution of the query, the information retrieval system may filter or locate results based on geographic location in accordance with the information specified in the user profile. Though, it will be recognized that any suitable technique may be used to process a search query and retrieve data. For example, a first model or set of models may be selected, e.g., by model selector 210, to affect information location and retrieval.

Based on the query and/or the retrieved data, appropriate second model(s) may then be selected by the search stack, such as by model selector 210 of FIG. 2. In the example of FIG. 6, the second model specified in FIG. 4 relating houses for sale to a user's commute is selected based on the portion of the query text, “near my office.”

The selected second model(s) may then be retrieved and applied to the data (i.e., the web pages of houses for sale) resulting from the search. The application of the second model(s) to the data may be performed, for example, by model application engine 216. In the example of FIG. 6, the user's office location may also be a value of an input parameter to the selected second model. Because the query text “near my office” does not specify the exact office location, in this example, the user's office location may be taken from the user's profile or the user's context, for example. In this example, as discussed in connection with FIG. 4, applying the selected second model comprises determining the GPS coordinates of the address, city and state of each house for sale from the search results, computing the commuting distance between each house and the user's office, and arranging the generated information to display the commuting distance alongside the description of each house for sale. In the example of FIG. 6, the display of the generated information has also been sorted based on commuting distance.

Thus, in the example of FIG. 6, two listings of houses for sale are returned by the search stack and displayed in the web browser, returned information elements 606 and 608. Each of returned information 606 and 608 includes a picture 610 and 612, respectively, of the house for sale and a description 614, and 616, respectively, of the house for sale. In addition, returned information elements 606 includes commuting information 618, “2 miles from work,” displayed alongside description 614, and returned information 608 includes commuting information 620, “5 miles from work,” displayed alongside description 616. In the example of FIG. 6, returned information elements 606 and 608 are returned as being sorted in ascending order based on commuting distance.

Accordingly, as the result of the application of the model specified by the example of FIG. 4, more useful information is returned to the user. That is, instead of merely returning a list of houses for sale, the information retrieval system of the present invention may return information to the user which is tailored to better fulfill the user's needs. The returned information may be based on additional dynamic computations that are performed specific to the user or his query (i.e., based on his office location), performed based on dynamically identified data (houses for sale in this example), and arranged or presented to the user in a more informative manner. Accordingly, applying selected model(s) enables the information retrieval system to locate, retrieve and provide information to the user that is more pertinent to his search query.

Model(s) selected and applied to a searching process carried out by a search stack may be created by an operator of the search stack, generated by an extractor 262 as described above, or they may be provided by third parties. Such third parties may include businesses, organizations or individuals that have a specialized desire or ability to specify the nature of information to be generated in response to a search query.

In some instances, models can be provided by any individual or organization making structured data, such as a spreadsheet, web service, or RSS feed, available on a network. For example, the individual or organization may include the model as metadata with the structured data, or include a reference in the data to the model. In some cases, the model may be included with the structured data in a header and/or in accordance with a schema.

In the case of a model that computes commuting distance from a house for sale, such as the model specified by the example of FIG. 4, the model may have been provided by a real estate agent. As another example, a model that computes comparative lab results may be provided by a medical association. As yet another example, a camera enthusiast or a camera retailer may provide a model that performs calculations involving specifications of the camera (e.g., optical zoom level, weight, or megapixel range, typical accessories purchased with the camera) that could be applied to a suitable query, such as, “camera for light travel.” As a fourth example, a fashion designer may provide a model with aesthetics logic that may rank and cluster clothes and accessories (e.g., according to style, color, cut, occasion) within search results. A weather scientist, as a fifth example, may provide a model to project the weather for a particular location (e.g., to project snow conditions over the next seven days for a micro-climate in the Cascades using a polynomial that is curve-fitted to the scientist's local observations) which may be applied in response to a suitable query in which the application of the model may be valuable e.g., “skiing conditions in Cascades.” As yet another example, a dietician or health organization may provide a model that calculates information pertaining to a particular diet (e.g., recommended daily allowance (RDA)) about a food item, so that when a user searches for food recipes, for example, the model may be triggered and calculate the percentage of RDA of fat or carbohydrates that is in one serving of the recipe.

### Method Embodiments

In view of the foregoing structural and operational descriptions relating to various embodiments of the invention, it will be appreciated by those skilled in the art that various inventive methods or processes may be executed. An embodiment of one method is described in connection with FIG. 5. Additional embodiments of methods are described below. When methods or processes are described, the listing of method steps should not be interpreted as a required order of performing steps, unless explicitly stated. In some cases, steps from two or more methods may be combined in total or in part to comprise a method within the scope of the invention. For example, one or more steps from one or more second or third described methods may be added to or substituted for one or more steps of a first described method.

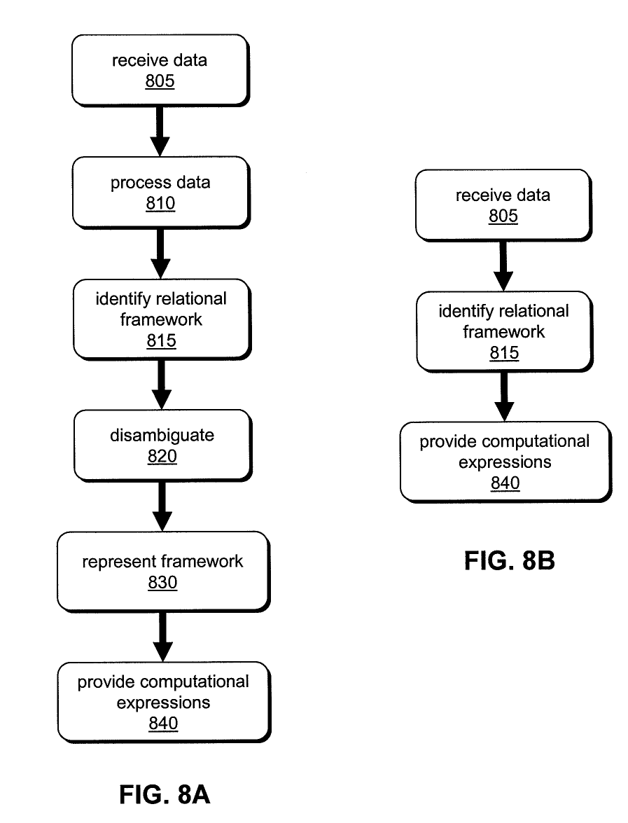

Referring now to FIGS. 8A-8B, flow diagrams depicting embodiments of methods that may be carried out by extractor 262 are shown. One method 800 for extracting higher-order knowledge from data, as illustrated in FIG. 8A, may comprise the steps of receiving 805 data, processing 810 the received data, identifying 815 at least one relational framework in the received data, and representing 830 the at least one relational framework by one or more computational expressions. The method may further comprise a step of disambiguating 820 the at least one identified relational framework, e.g., prompting a user or model author for input to establish a correct relational framework for processed data. The method may also include providing 840 the one or more computational expressions to an information retrieval system.

The step of receiving 805 data can comprise receiving, by at least one processor in communication with an information retrieval system, structured data from any suitable source, including from crawling a network or receiving data from a provider of structured data. The at least one processor may be a processor of extractor 262. The received data may comprise structured data, e.g., data of a certain structure type such as a list, table, sequence, record, spreadsheet, graph, etc. The relational framework may be representative of a higher-order knowledge, or representative of at least one characteristic of a higher-order knowledge.

In various embodiments, the at least one processor processes 810 the received data. The processing may include determining whether structured data is present, e.g., determining the presence of a table, a list, a graph. The processing may further include analyzing the data to determine a relationship between portions of data. In certain embodiments, the processing can include determining aspects of the relational framework from metadata or a header associated with the data.

As a result of processing 810 the received data, the at least one processor may identify 815 at least one relational framework associated with the data. The step of identifying can comprise pattern matching, or applying one or more classifiers or other processing techniques adapted to identify relationships based on data. Though in some embodiments, the processing may entail reading an equation from the data. The relationship may be read from the data, for example, where the data is a spreadsheet, such as an Excel® spreadsheet that may be programmed with formulas relating data in cells of the spreadsheet. In some embodiments, the step of identifying 815 may include identifying that a group of data appears to have some relational framework, but that the group of data does not appear to belong to a recognizable type of relational framework. The step of identifying 815 may also include identifying plural types of relational framework for received data.

An optional step of disambiguating 820 may be included in certain embodiments of the method 800 for extracting higher-order knowledge from data. The step of disambiguating may comprise providing the received data to a user 202 or model author 254 for review and determination by the user or model author of what relational framework is evident in the received data. The received data may be provided, by the extractor 262, to the user or model author along with candidate types of relational frameworks, and the user or model author may select one of the candidate types. Disambiguation may be used, for example, when a relationship is detected by the types of data to which the relationship applies is not detected automatically. Similarly, disambiguation may be applied when the context in which the relationship applies is not determined automatically but is provided by input from a model author. Similar disambiguation may be applied when multiple possible relationships are detected in data, though none is detected with a confidence exceeding a threshold.

After identification of a relational framework is completed for received data, the at least one processor may represent 830 the relational framework with one or more computational expressions which capture the higher-order knowledge indicative of the relational framework. As described above, the computational expressions may include mathematical expressions, Boolean expressions, rules, conditional statements, string calculations, declarative expressions, etc. that are recognizable and/or executable by the information retrieval system. In various embodiments, the expressions are provided to the information retrieval system for execution by the information retrieval system. Their execution affects results provided to a user 202 responsive to a search query.

FIG. 8B depicts an additional embodiment of a method for extracting higher-order knowledge from structured data. The method of FIG. 8B may comprise the steps of receiving 805 data by the at least one processor of extractor 262, identifying 815 at least one relational framework, and providing 840 computational expressions to an information retrieval system. In certain embodiments, the received data may be marked up with metadata which identifies the relational framework as well as additionally identifying computational expressions representative of the relational framework. In such embodiments, the extractor 262 may identify the relational framework and computational expressions from the metadata. The identified computational expressions may then be passed directly or modified and provided 840 to the information retrieval system.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention may be implemented in any of numerous ways. For example, the embodiments may be implemented using hardware, software or a combination thereof. When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media may be transportable, such that the program or programs stored thereon may be loaded onto one or more different computers or other processors to implement various aspects of the present invention as discussed above. As used herein, the term “non-transitory computer-readable storage medium” encompasses only a computer-readable medium that may be considered to be a manufacture (i.e., article of manufacture) or a machine.

The terms “program” or “software” are used herein in a generic sense to refer to any type of computer code or set of computer-executable instructions that may be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for use in searching for and retrieving information on a plurality of data storage devices, the method comprising:
receiving, by at least one processor in communication with an information retrieval system, data structured according to at least one relational framework, the relational framework being at least one characteristic of a higher-order knowledge;
processing, by the at least one processor, the received data to identify the at least one relational framework;
representing, by the at least one processor, the at least one relational framework as one or more computational expressions, the one or more computational expressions executable by at least one computer processor.

2. The method of claim 1 further comprising providing, by the at least one processor, the one or more computational expressions to an information retrieval system for use in generating information returned to a user in response to a search query.

3. The method of claim 2 further comprising, with the information retrieval system, receiving a search query;
generating search results in response to the search query; and
applying the one or more computational expressions to the search results.

4. The method of claim 1, wherein the received data is data generated by a component crawling a network.

5. The method of claim 1, wherein the received data comprises at least a portion of a document, the portion comprising a structure type selected from the following group: a list, a table, a record, a graph, a sequence, and a spreadsheet.

6. The method of claim 1, wherein the at least one relational framework is identified in metadata or a schema associated with a spreadsheet.

7. The method of claim 1, wherein the each one of the one or more computational expressions represents a calculation or function identified in a spreadsheet.

8. The method of claim 1, wherein the each one of the one or more computational expressions comprises a computer-executable expression type selected from the following group: a rule, a constraint, a Boolean expression, a declarative expression, a conditional statement, a mathematical expression, and any combination thereof.

9. The method of claim 1, wherein the identifying comprises:
identifying a grouping of data that does not correspond to a processor-recognizable relational framework;
providing the group of data to a user or model author; and
receiving input from the user of model author identifying a relational framework for the group of data.

10. A system for searching for and retrieving information provided by a plurality of data storage devices, the system comprising:
an input component configured to receive data from at least one networked data storage device;
an output component configured to transmit data to at least one information retrieval system; and
at least one processor adapted to:
identify at least one computational expression representative of a relational framework for data received by the input component, the relational framework relating a portion of the received data to another portion of the received data, the relational framework being at least one characteristic of a higher-order knowledge; and
provide the at least one computational expression to an information retrieval system for use in generating information returned to a user in response to a search query.

11. The system of claim 10, wherein identifying the at least one computational expression comprises identifying the computational expression based at least in part on a calculation or function identified in a spreadsheet.

12. The system of claim 10, wherein the at least one computational expression comprises a computer-executable expression type selected from the following group: a rule, a constraint, a Boolean expression, a declarative expression, a conditional statement, a mathematical expression, and any combination thereof.

13. The system of claim 10, wherein the identifying the at least one computational expression comprises identifying a data structure type in at least a portion of the received data and analyzing the data structure type.

14. The system of claim 13, wherein the data structure type comprises an element selected from the following group: a list, a table, a record, a graph, a sequence, and a spreadsheet.

15. The system of claim 10, wherein the at least one computational expression is incorporated as a model for use in searching by the information retrieval system.

16. The system of claim 10, wherein the at least one computational expression is incorporated in a search stack of the information retrieval system.

17. The system of claim 10, wherein the relational framework is identified in metadata or a schema associated with a spreadsheet.

18. A manufactured non-transitory computer storage medium comprising:
computer-executable instructions that, when executed by at least one processor, adapt the at least one processor to perform a method comprising:
receiving at least one spreadsheet;
processing the at least one spreadsheet to identify a computational expression representative of a relational framework for a plurality of data within the spreadsheet data structure; and
providing the computational expression to an information retrieval system for use in searching for information desired by a user.

19. The computer storage medium of claim 18, wherein the computer-executable instructions further adapt the at least one processor to identify the computational expression in metadata or a schema associated with the spreadsheet.

20. The computer storage medium of claim 18, wherein the each computational expression comprises a calculation or function identified in a spreadsheet.
